(19) United States
(12) Patent Application Publication
(10) Pub. No.: US 2009/0080468 A1
(43) Pub. Date: Mar. 26, 2009

(54) Locally perturbed optical fibers for mode transformers

(76) Inventor: Mikhail Sumetsky, Bridgewater, NJ (US)

Correspondence Address: Law Office of Peter V.D. Wilde, 301 East Landing, Williamsburg, VA, 23185, US

(21) Appl. No.: 11/903,759

(22) Filed: Sep. 25, 2007

(51) Int. Cl. G02B 6/14; H01S 3/067

(52) U.S. Cl. 372/6; 385/28

(57) ABSTRACT

The specification describes optical devices and related methods wherein the input has multiple modes, and at least one of the multiple modes are respectively converted by one or more multiple mode transformers to produce an output with predetermined modes that are different from the input. In one embodiment the output mode is a single mode. In another embodiment the power ratios of the input modes are controllably changed. In another embodiment one or more output mode is different from the input mode.

### FIELD OF THE INVENTION

The invention relates to optical fiber mode controlling devices.

### BACKGROUND OF THE INVENTION

Optical fiber and optical waveguide mode converters are well known and come in a variety of forms. They operate typically by transforming an input mode, usually a fundamental mode, into a higher order mode, or vice versa. An especially attractive mode converter device comprises a long period grating (LPG) formed in an optical fiber. See for example, U.S. Pat. No. 6,768,835, and T. Erdogan, “Fiber grating spectra,” J. Lightwave Technology vol. 15, p. 1277 (1997).

These mode converters operate with a single mode input, and typically a single mode output. Propagating light in more than one mode at a time, and controllably changing the mode of more than one mode at a time, would be an attractive goal, but to date not achieved.

### SUMMARY OF THE INVENTION

I have designed an optical device and related method wherein the input has multiple modes, and the multiple modes are respectively converted by multiple mode transformers to produce an output with predetermined modes that may be different from the input. In one embodiment the output mode is a single mode. In another embodiment the power ratios of the input modes are controllably changed. In another embodiment one or more output mode is different from the input mode.

### BRIEF DESCRIPTION OF THE DRAWING

FIG. 1 shows a mode transformer diagram and a schematic form of a mode transformer according to one embodiment of the invention;

FIG. 2 is a schematic representation of multiple mode transformers;

FIG. 3 shows a mode transformer diagram and a schematic form of a mode transformer which is a modified version of the multiple mode transformers of FIG. 2; and

FIG. 4 is an illustration of a cladding pumped device using multiple mode transformers.

### DETAILED DESCRIPTION

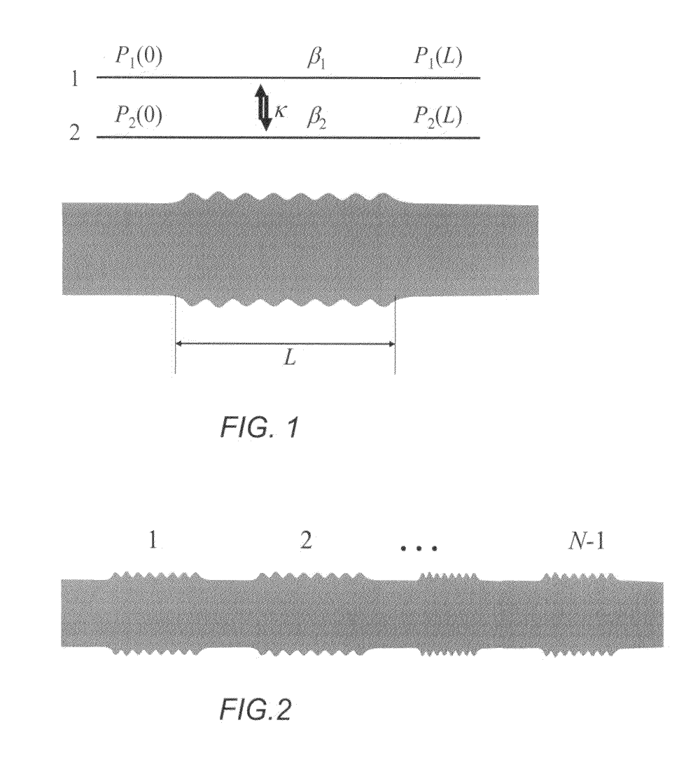

The simplest case of coupling between several copropagating modes is coupling between two modes. Conversion between two modes can be performed with a long period grating (LPG), which periodically changes the effective refractive index of the fiber according to the following equation:

$${n}_{eff} ( z ) = {n}_{0} + Δ n cos ( \frac{2 π}{Λ} z + θ ) \qquad ( 1 )$$

where Λ is the period of the LPG. Assume that the LPG starts at z=0 and ends at z=L (see FIG. 1). Consider modes 1 and 2 having the propagation constants β₁ and β₂, respectively. For determinacy, assume that β₂>β₁. In the absence of LPG, at z<0, modes 1 and 2 have the form:

E₁(x,y,z)=C₁₀exp(iβ₁z+φ₁)e₁(x,y)

E₂(x,y,z)=C₂₀exp(iβ₂z+φ₂)e₂(x,y)′ (2)

Here z is the coordinate along the fiber, x, y are the transverse coordinates, eⱼ(x, y) are the real-valued transverse mode distribution, and Cⱼ₀ and φⱼ are constants, which determine the amplitudes and the phases of modes, respectively. When these modes enter the section of the fiber containing the LPG, the coordinate dependence can be written in the form:

$$\begin{matrix}\begin{matrix}{E}_{1} ( x , y , z ) = {A}_{1} ( z ) exp \{ i [ {β}_{1} - δ + \frac{1}{2} ( {σ}_{11} + {σ}_{22} ) ] z + \frac{i}{2} θ \} {e}_{1} ( x , y ) \\ {E}_{2} ( x , y , z ) = {A}_{2} ( z ) exp \{ i [ {β}_{2} + δ + \frac{1}{2} ( {σ}_{11} + {σ}_{22} ) ] z - \frac{i}{2} θ \} {e}_{2} ( x , y ) ,\end{matrix} \\ where & ( 3 ) \\ δ = \frac{1}{2} ( {β}_{1} - {β}_{2} ) + \frac{π}{Λ} , & ( 4 )\end{matrix}$$

σⱼⱼ are the “dc” coupling coefficients [see e.g. T. Erdogan, “Fiber grating spectra,” J. Lightwave Technology vol. 15, p. 1277 (1997)], and Aⱼ(z) are the functions, which are determined by the coupling wave equations:

$$\frac{d {A}_{1}}{d z} = i σ {A}_{1} + i κ {A}_{2} \\ \frac{d {A}_{2}}{d z} = i κ {A}_{2} - i σ {A}_{2} \qquad ( 5 )$$

Here σ is the general “dc” self-coupling coefficient and κ is the “ac” cross-coupling coefficient. Comparing Eq. (2) and Eq. (3), the initial conditions for Aⱼ(z) are:

$$\begin{matrix}{A}_{1} ( 0 ) = {C}_{10} exp [ i ( {ϕ}_{1} - \frac{θ}{2} ) ] \\ {A}_{2} ( 0 ) = {C}_{20} exp [ i ( {ϕ}_{2} + \frac{θ}{2} ) ]\end{matrix} \qquad ( 6 )$$

### Solution of Eq. (5) is:

$$\begin{matrix}{A}_{1} ( z ) = ( cos ( μ z ) + i \frac{σ}{μ} sin ( μ z ) ) {A}_{1} ( 0 ) + i \frac{κ}{μ} sin ( μ z ) {A}_{2} ( 0 ) \\ {A}_{2} ( z ) = i \frac{κ}{μ} sin ( μ z ) {A}_{1} ( 0 ) + ( cos ( μ z ) - i \frac{σ}{μ} sin ( μ z ) ) {A}_{2} ( 0 )\end{matrix} \qquad ( 7 )$$

where μ=\sqrt{σ²+κ²}. The power of the mode j is determined as:

Pⱼ(z)=∫dxdyEⱼ(x,y,z)Eⱼ*(x,y,z)=|Aⱼ(z)|² (8)

Here it is assumed that the transverse components of the modes are normalized:

∫dxdyeⱼ(x,y)eⱼ*(x,y)=1 (9)

It is possible to find the LPG parameters θ, σ, κ, and L, so that, for arbitrary Cⱼ₀ and φⱼ, the requested Aⱼ(L) at z=L can be obtained, which satisfy the energy conservation rule:

Pⱼ(L)+P₂(L)=P₁(0)+P₂(0) (10)

where

Pⱼ(0)=|Aⱼ(0)|², Pⱼ(L)=|Aⱼ(L)|² (11)

The corresponding equations for σ, κ, and L are found from Eq. (7):

$$\begin{matrix}cos ( μ L ) = Re X & ( 12 ) \\ \frac{κ}{μ} = - \frac{i Y}{\sqrt{1 - {( Re X )}^{2}}} \\ where & ( 13 ) \\ X = \frac{{A}_{1}^{*} ( 0 ) {A}_{1} ( L ) + {A}_{2} ( 0 ) {A}_{2}^{*} ( L )}{{\vert {A}_{1} ( 0 ) \vert}^{2} + {\vert {A}_{2} ( 0 ) \vert}^{2}} & ( 14 ) \\ Y = \frac{{A}_{2}^{*} ( 0 ) {A}_{1} ( L ) - {A}_{1} ( 0 ) {A}_{2}^{*} ( L )}{{\vert {A}_{1} ( 0 ) \vert}^{2} + {\vert {A}_{2} ( 0 ) \vert}^{2}} & ( 15 )\end{matrix}$$

Eq. (13) is self-consistent only if the right hand side is real. From Eq. (15), the later condition is satisfied if

Re(A₂*(0)A₁(L))=Re(A₁(0)A₂*(L)). (16)

Eq. (16) can be satisfied with appropriate choice of the LPG phase shift, θ. Thus, the input modes 1 and 2, with arbitrary amplitudes and phases, can be converted into any other modes, with arbitrary amplitudes and phases, if the condition of the energy conservation, Eq. (10), is fulfilled.

In some applications, it may be necessary to convert two modes with known input powers, P₁(0) and P₂(0) into two modes with the requested power ratio P₂(L)/P₁(L) and with no restrictions on the phases of A₁(L) and A₂(L). This conversion can be performed with the simplified LPG, which satisfies the phase matching condition, σ=0. For example, assume the condition that after passing the coupling region of length L, the light is completely transferred to mode 1 and mode 2 is empty:

P₁(L)=P₁(0)+P₂(0), P₂(L)=0, Pⱼ(L)=|Aⱼ(L)|². (17)

This condition can be satisfied independently of the initial phases of A₁(O) and A₂(0) only if one of the initial powers is zero. For example, if P₁(0)=0 then Eq. (4) is satisfied if

cos(κL)=0 (18)

This result is used in mode conversion based on long period fiber gratings. However, if both of initial powers P₁(0) and P₂(0) are not zeros, Eq. (17) can be satisfied when the initial phase difference between modes 1 and 2 is

$$arg ( {A}_{1} ( 0 ) / {A}_{2} ( 0 ) ) = \pm \frac{π}{2} \qquad ( 19 )$$

Then the condition of full conversion of modes 1 and 2 into mode 1 is:

$$tan ( κ L ) = \frac{i {A}_{2} ( 0 )}{{A}_{1} ( 0 )} \qquad ( 20 )$$

The right hand side of this equation is real due to Eq. (19). Thus, in order to perform essentially full conversion of light, which is arbitrarily distributed between two modes, the initial phases of these modes should be adjusted and the coupling coefficient κ and coupling length L should be chosen from Eq. (20). Furthermore, if the phase condition of Eq. (19) is satisfied then it can be shown that the powers of modes can be arbitrarily redistributed with the appropriate choice of coupling parameters. In fact, assume that the ratio of the input mode powers is R₀=P₁(0)/P₂(0). Then in order to arrive at the output mode ratio R_{L}=P₁(L)/P₂(L), the coupling coefficient κ may be defined from the equation:

$$tan ( κ L ) = ∓ \frac{{R}_{0}^{1 / 2} + {R}_{L}^{1 / 2}}{1 - {( {R}_{0} {R}_{L} )}^{1 / 2}} , \qquad ( 21 )$$

where the signs ∓ correspond to ± in Eq. (19). Eq. (20) is derived from Eq. (7) for σ=0. For the condition of full mode conversion, R_{L}=∞, Eq. (21) coincides with Eq. (18). Practically, Eq. (21) can be satisfied by choosing the appropriate LPG strength and length. Eq. (19) can be satisfied by changing the length of the fiber in front of LPG by heating, straining, or with other type of refractive index perturbation or deformation. Such perturbations and deformations are described in U.S. Pat. No. 6,768,835, which is incorporated herein by reference. This condition can be also satisfied by inscribing the LPG at the proper place along the fiber length.

This basic teaching can be extended to the more general case wherein light propagating along M modes with amplitudes A₁⁰, . . . , A_{M}⁰ is converted to the same or other N modes with amplitudes A₁^{f}, . . . , A_{M}^{f}. This can be done by a series of two or more mode couplers described above and illustrated in FIG. 2. Due to energy conservation:

P₁⁰+ . . . +P_{M}⁰=P₁^{f}+ . . . Pₙ^{f}, Pⱼ^{0, f}=|Aⱼ^{0, f}|². (22)

Without loss of generality, assume M=N, which can be always done by adding empty modes. If P₁⁰ is the largest power among the initial partial powers and P₁^{f} is the smallest power among the final partial powers then, according to Eq. (22), we have P₁⁰≧P₁^{f}. The first two-mode transformation fills mode 1 with the desired power: P₁⁰+P₂⁰→P₁^{f}+P₂′ where P₂′=P₁⁰+P₂⁰−P₁^{f}. In the result of this transformation, the problem of conversion is reduced to the case of N−1 modes, which can be solved similarly. Thus, any power redistribution between two sets of N modes can be performed with a series of N−1 two-mode transformations as illustrated in FIG. 2.

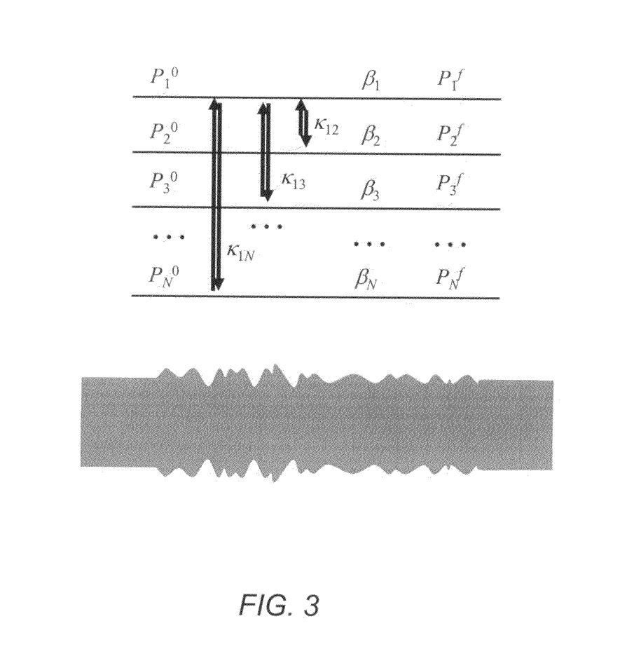

In the device of FIG. 2 the mode transformers are arranged serially along the optical fiber length. Alternatively, essentially the same result can be achieved using superimposed LPGs, which simultaneously performs coupling and transformations between several modes. A particular objective may be the conversion of N modes with arbitrary power distribution, P₁⁰, . . . , P_{N}⁰, into a single mode 1. The mode conversion diagram and superimposed LPG are illustrated in FIG. 3. In FIG. 3, the physical geometry of the perturbations is a summation of the geometries of the four gratings shown in FIG. 2, superimposed on top of one another. The LPGs are chosen to perform coupling between mode 1 and all other modes, while the intermode coupling between modes, which have numbers greater than one, is zero. The coupling wave equations, which describe the considered system are:

$$\frac{d {A}_{1}}{d z} = i ( {κ}_{12} {A}_{2} + {κ}_{13} {A}_{3} + … + {κ}_{1 N} {A}_{N} ) \\ \frac{d {A}_{2}}{d z} = i {κ}_{12} {A}_{1} \\ \frac{d {A}_{N}}{d z} = i {κ}_{1 N} {A}_{1} \qquad ( 23 )$$

These equations are the generalization of the coupling mode equations, Eq. (5). The initial power distribution is:

P₁⁰=|A₁(0)|², P₂⁰=|A₁(0)|², . . . , P_{N}⁰=A_{N}(0)|² (24)

Solution of Eq. (23) with these boundary conditions leads to the following condition of conversion of all modes into the single mode 1:

$$tan ( L \sqrt{{\sum }_{n = 2}^{N} {κ}_{1 n}^{2}} ) = \frac{i}{{A}_{1} ( 0 )} \sqrt{{\sum }_{n = 2}^{N} {[ {A}_{n} ( 0 ) ]}^{2}} , \qquad ( 25 )$$

which can be satisfied only under the condition of the phase shifts:

$$arg ( {A}_{1} ( 0 ) / {A}_{n} ( 0 ) ) = \pm \frac{π}{2} , n = 2 , 3 , … , N , \qquad ( 26 )$$

Eq. (26) means that the difference between phases of all modes except mode 1 should be equal to zero or π, while the difference between the phase of mode 1 and the phases of other modes should be ±π/2. For the particular case of N=2, Eqs. (25) and (26) coincide with Eq. (20) and (19), respectively. Results show that, using superimposed LPGs, it is possible to convert the arbitrary distributed modes into a single mode if the phases of modes are appropriately tuned. The phases of LPGs can be tuned by shifting the positions of individual LPGs with respect to each other by, for example, using the mechanisms described earlier.

A variety of applications will be found for the mode transformers described here. For example, in cladding pumped devices such as lasers and amplifiers it is useful to transform modes in the gain section to enhance interactions between the signal and the pump energy. Conventional cladding-pumped optical fiber lasers and amplifiers operate with the signal light propagating along the core of the fiber and the signal is amplified with pump light propagating along both the fiber cladding and fiber core. At each cross-section of the fiber, signal amplification is performed only by a fraction of the pump light. For this reason, in the process of pumping, the propagating modes of the pump light are attenuated proportionally to their intensity at the fiber core. In particular, the modes of the pump light, which are propagating primarily along the fiber cladding, are attenuated much less than the modes having significant intensity at the fiber core. To ensure the effective pumping, it is important to maximize the intensity of the pump light near the fiber core. Transforming the modes in the gain section using mode transformers of the invention produces a mode pattern where most of the modes can be distributed uniformly along the fiber cross-section, and have a finite intensity in the core region. As a result, for sufficiently long fiber almost all of the pump light can be transformed into the signal light. The intensity of pump light is thus maximized at the core region, which is important to perform more effective pumping at shorter fiber lengths.

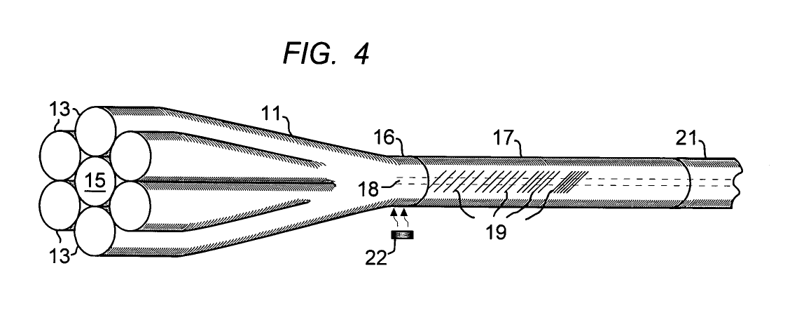

A cladding pumped device with mode transformers according to the invention is shown in FIG. 4. The device may be either an optical fiber laser device or an optical fiber amplifier device, both of which have a gain section and an optical pump for introducing light energy into the cladding of the gain section. With reference to FIG. 4, a conventional pump combiner section is shown at 11. Pump combiners of this kind are described in detail in U.S. Pat. No. 5,864,644, which is incorporated herein by reference for that description. A plurality of multimode optical pump fibers 13, shown here as six, are bundled in a circular configuration as shown. The optical fiber carrying the signal to be amplified, or the optical fiber with the active laser cavity in the case of a laser device, is shown at 15. In parts of this description, the active waveguide, whether for a laser or an amplifier, will be referred to as the signal fiber. The bundle is fused together, and drawn to produce the combined section shown at 16. In this illustration, the reduction produced by drawing is approximately one-third, and the core of the signal fiber is reduced by approximately one third. The pump combiner section is spliced to a gain section, shown at 17. The optical fiber core is shown in phantom at 18. The gain section 17 has four mode transformers shown schematically at 19. In this embodiment the mode transformers are long period gratings (LPGs). The LPGs extend into the cladding as shown. This is important if the gratings are to effectively transform higher order modes propagating outside the core. The output fiber is shown at 21. Splices (not shown) connect the various optical fiber sections.

It should be understood that the drawing is not to scale. For example, the gain section 17 is typically much longer.

The LPG mode transformers 19 may be arranged serially, similar to those in FIG. 2, or may be superimposed, as those in FIG. 3. In both cases the mode transformer elements may be superimposed completely or partially.

The spacing separating the LPGs in FIG. 4, and the placement of the LPG along the optical fiber are important parameters in the operation of the device. These can be tuned in the manner described above. A tuning device is shown schematically at 22. In this case the tuning device is shown as a heating element to vary the refractive index of the optical fiber. Other tuning devices may be used.

The construction and design of LPGs is known in the art. Mode converters made using LPGs are described in more detail in U.S. Pat. No. 6,768,835, issued Jul. 27, 2004, which is incorporated herein by reference.

In the embodiment of FIG. 1 a single mode transformer is used with multiple mode inputs and one or more mode outputs. In the embodiment of FIGS. 2-4, multiple mode transformers are used with multiple mode inputs and multiple mode outputs. It should be evident that any number of modes can be processed according to the invention with a very large potential combination of inputs and outputs. The effect of the mode transformers may be to convert the modes to another mode, or to increase or decrease the power ratio between the input modes.

In embodiments described by FIGS. 2-4, the general case where multiple mode inputs and multiple mode outputs are involved is two input modes, two mode transformers and two output modes. This is a basic building block of a very large number of potential devices processing a large number of different mode transformations. The following table describes the options using the basic building blocks. R refers to the power ratio between modes, α refers to the phase of the input mode, and β refers to the phase of the output mode.

| | INPUT | OUTPUT |
|---|---|---|
| (FIG. 1) | M₁, M₂ | M₁ |
| (FIGS. 1-4) | M₁, M₂ with R₁ | M₁, M₂ with R₂ |
| | M₁, M₂ with R₁, α₁ and α₂ | M₁, M₂ with R₂, β₁ and β₂ |
| | M₁, M₂ | M₁, M₃ |
| | M₁, M₂ with R₁ | M₁, M₃ with R₂ |
| | M₁, M₂ with R₁, α₁ and α₂ | M₁, M₃ with R₂, β₁ and β₃ |
| | M₁, M₂ | M₃, M₄ |
| | M₁, M₂ with R₁ | M₃, M₄ with R₂ |
| | M₁, M₂ with R₁, α₁ and α₂ | M₃, M₄ with R₂, β₃ and β₄ |

It should be understood that the chart above describes basic elements of devices constructed according to the principles of the invention. In many cases, the basic elements, and functions of basic elements, will be combined to produce complex mode transforming devices, and the inputs will be multiplied to produce complex outputs with modified mode patterns. Thus although the claims may minimally specify methods and devices comprising these basic elements, it is contemplated that many methods and devices in practice will have added elements and combinations of elements. It should be understood that these variations and extensions are within the scope of the claims.

The specific waveguides in the embodiments shown in the figures are optical fiber waveguides. However, the equations given above are general waveguide equations and apply to other forms of waveguides as well. For example, the invention may be implemented with planar optical waveguides in optical integrated circuits. These options may be described using the generic expression optical or electromagnetic field waveguide.

Various additional modifications of this invention will occur to those skilled in the art. All deviations from the specific teachings of this specification that basically rely on the principles and their equivalents through which the art has been advanced are properly considered within the scope of the invention as described and claimed.

1. A method comprising:
a) introducing a first optical mode into an optical or electromagnetic field waveguide,
b) simultaneously introducing a second optical mode into the waveguide,
c) using a long period grating (LPG) mode transformer, transforming at least a portion of the first optical mode into the second optical mode, wherein the portion of the first optical mode is determined by preselected properties of the LPG mode transformer.

2. A method comprising:
a) introducing a first optical mode into an electromagnetic filed waveguide,
b) simultaneously introducing a second optical mode into the waveguide,
c) using LPG mode transformers,
i) transforming at least a portion of the first optical mode into another optical mode,
ii) transforming at least a portion of the second optical mode into another optical mode,
wherein the portion of the first optical mode and the portion of the second optical mode are both determined by preselected properties of the LPG mode transformers.

3. The method of claim 2 wherein the portion of the first optical mode is transformed into a third optical mode, and the third optical mode is different from the first and second optical modes.

4. The method of claim 3 wherein the portion of the second optical mode is transformed into a fourth optical mode, and the fourth optical mode is different from the first, second, and third optical modes.

5. The method of claim 2 wherein steps a) and b) define an input and step c) defines an output and the input and output are selected from the group consisting of 1-5 in the following table:

| INPUT | OUTPUT |
|---|---|
| 1) M₁, M₂ with R₁, α1 and α2 | M₁, M₂ with R₂, β₁ and β₂ |
| 2) M₁, M₂ | M₁, M₃ |
| 3) M₁, M₂ with R₁, α1 and α2 | M₁, M₃ with R₂, β₁ and β₂ |
| 4) M₁, M₂ | M₃, M₄ |
| 5) M₁, M₂ with R₁, α1 and α2 | M₃, M₄ with R₂, β₁ and β₂ |

where M₁, M₂, M₃ and M₄ represent different optical modes, R₁ and R₂ are power ratios of those modes, and α and β are the phases of those modes.

6. The method of claim 1 where the optical waveguide is an optical fiber.

7. The method of claim 2 wherein the optical fiber comprises a core and a cladding and the method further includes the step of introducing optical pump radiation into the cladding.

8. The method of claim 7 wherein a signal is introduced into the optical fiber and the signal is amplified by coupling to the optical pump radiation.

9. The method of claim 7 wherein the optical fiber produces laser light.

10. An optical device comprising:
a) an optical fiber,
b) an input to the optical fiber comprising first and second optical modes,
c) a first LPG mode transformer adapted to transform at least a portion of the first optical mode into the second optical mode,
wherein the portion of the first optical mode is determined by properties of the LPG mode transformer.

11. An optical device comprising:
a) an optical or electromagnetic waveguide,
b) an input to the waveguide comprising first and second optical modes,
c) a first LPG mode transformer adapted to transform at least a portion of the first optical mode into another optical mode,
d) a second LPG mode transformer adapted to transform at least a portion of the second optical mode into another optical mode,
wherein the portion of the first optical mode and the portion of the second optical mode are both determined by properties of the LPG mode transformers.

12. The optical device of claim 11 wherein the input modes and the output modes are selected from the group consisting of 1-5 in the following table:

| INPUT | OUTPUT |
|---|---|
| 1) M₁, M₂ with R₁, α1 and α2 | M₁, M₂ with R₂, β₁ and β₂ |
| 2) M₁, M₂ | M₁, M₃ |
| 3) M₁, M₂ with R₁, α1 and α2 | M₁, M₃ with R₂, β₁ and β₂ |
| 4) M₁, M₂ | M₃, M₄ |
| 5) M₁, M₂ with R₁, α1 and α2 | M₃, M₄ with R₂, β₁ and β₂ |

where M₁, M₂, M₃ and M₄ represent different optical modes, R₁ and R₂ are power ratios of those modes, and α and β are the phases of those modes.

13. The optical device of claim 11 wherein the LPG mode transformers comprise regions of varying optical fiber diameter.

14. The optical device of claim 10 wherein the LPG mode transformers comprise photoinduced LPGs.

15. The optical device of claim 10 wherein the optical fiber comprises a core and a cladding and further includes an optical pump for introducing pump radiation into the cladding.

16. The optical device of claim 14 wherein the optical fiber is the gain section optical fiber amplifier.

17. The optical device of claim 14 wherein the optical fiber is the gain section optical fiber laser.
